(19) United States
(12) Patent Application Publication
(10) Pub. No.: US 2009/0063235 A1
(43) Pub. Date: Mar. 5, 2009

(54) CONTROL SYSTEM FOR ENTERPRISE PRODUCTION BASED ON INVENTORY DATA

(75) Inventor: Liying GENG, Beijing (CN)

Correspondence Address: YING CHEN;Chen Yoshimura LLP, 255 S. GRAND AVE., # 215, LOS ANGELES, CA, 90012, US

(73) Assignee: Beijing Aotengxunda Science and Technology Co., Ltd, Beijing (CN)

(21) Appl. No.: 12/110,442

(22) Filed: Apr. 28, 2008

(30) Foreign Application Priority Data
Aug. 27, 2007 (CN) 200710120802.6

(51) Int. Cl. G06Q 90/00

(52) U.S. Cl. 705/8

(57) ABSTRACT

This invention relates to a control system for enterprise production based on inventory data. Said system is comprised of a central processing system and a or more data collection terminal to exchange data with the central processing system; the said data collection terminal collects the incoming/discharging data of all goods delivered to the said central processing system, which is used to make statistics, analysis and storage; the said central processing system is set up with a real-time inventory database, an optimum analysis database, a data statistics unit, an optimum analysis unit, a data store and output unit, a manual input device and a central control unit. This system could not only make a collection and statistics of warehouse data, but also optimize and control the inventory method, storage, and inventory time of goods according to the enterprise's operation status, and give an alarm when optimum problem occurs. This system is favorable to enhance the enterprise's overall operation and management level.

### BACKGROUND OF THE INVENTION

1. Field of the Invention

This invention relates to a control system for enterprise production based on inventory data and involves in information technology.

2. Description of the Related Art

As the computer technology becomes more and more popular, an enterprise, especially a large enterprise, usually uses a computer management system to collect its stock incoming/discharging data through one or more data collection terminal(s). Such data are counted, analyzed and stored by a central processing system, for a man to get inventory status of all goods at any time. However, these computer systems usually put emphasis on the collection of warehouse data and the automation of processing, aimed at knowing if there are goods available. Therefore, these computer systems could not be used to control an enterprise's operation in light of overall economic profits of the enterprise.

### SUMMARY OF THE INVENTION

To overcome the deficiencies of present technology, this invention offers a control system for enterprise production based on inventory data, which could not only be used in the collection of warehouse data and got statistics, but also be used to analyze and judge the enterprise's operation status, which is favorable to improve an enterprise's overall operation and management.

The technical solution to realize above purposes is: A control system for enterprise production based on inventory data, comprising a central processing system and a or more data collection terminal which exchanges data with the central processing system, wherein said data collection terminal collects the incoming/discharging data of all goods and delivered the data to the said central processing system, which counts the said data to get statistics and store it; the said central processing system is set up with a real-time inventory database, a optimum analysis database, a data statistics unit, an optimum analysis unit, a data store and output unit, a manual input device and a central control unit; the said data statistics unit is applied to get the incoming/discharging data of all goods collected by data terminal, read and make statistical calculation of the corresponding data in real-time inventory database, acquire the storage data, incoming/discharging time data, and goods character data of all goods, and delivery these data to real-time inventory database to store through the said data store and output unit; the said optimum analysis unit reads the storage data, incoming/discharging time data and goods character data of all goods in real-time inventory database, reads optimum program and optimum parameter of optimum analysis database to make optimum calculation: when the relevant material on one production line is disproportionate, to generate proportional imbalance information of the production line, when the storage of one goods exceeds the upper limit of optimum storage, to generate overstocking signal of the goods, when the storage of one goods is less than the lower limit of optimum storage, to generate stock-out signal and when the inventory time of one goods is achieving the alarm time, to generate alarm signal of overtime inventory and save signals in optimum analysis database to stock and display alarm by data store and output unit; the said data store and output unit is used to receive data from data statistics unit, optimum analysis unit and manual input device, and delivery the data to the relevant database for stock, or to read data in a corresponding database according to an instruction from natural data statistics unit, optimum analysis unit and manual input device and display these data; the said central control unit is used to control the coordination among the said data statistics unit, optimum analysis unit, data store and output unit as well as manual input device.

Since the system is mainly based on the enterprise's overall operation and management, timely finds problems possibly occur in production through inventory data analysis and display of enterprise's production and operation status, which offers extremely convenience for operation manager to connect with the situation and puts forward solutions to possible problems in time; meanwhile, the system is able to make optimum analysis of inventory and optimum control of storage and inventory time, except making automation of common warehouse management system, through automation and optimization of warehouse, so as to avoid overstocking and stock-out and prevent expiry resulted from long time stock, which reduces warehouse cost, warehouse risk and capital overstocking; since the optimum method could be regulated and amended in time according to the manual input, the optimum pattern could be altered at any time when the enterprise's internal management or external market condition changes, to achieve the optimal results. Additionally, this management system only needs simple hardware and low investment cost, but bears high automation degree and strong adaptability, which could automatically make optimum analysis by use of incoming/discharging data and is favorable to promote and apply without adding the workload of operator.

### BRIEF DESCRIPTION OF THE DRAWINGS

FIG. 1 is a structural scheme of this invention.

### DETAILED DESCRIPTION OF THE PREFERRED EMBODIMENTS

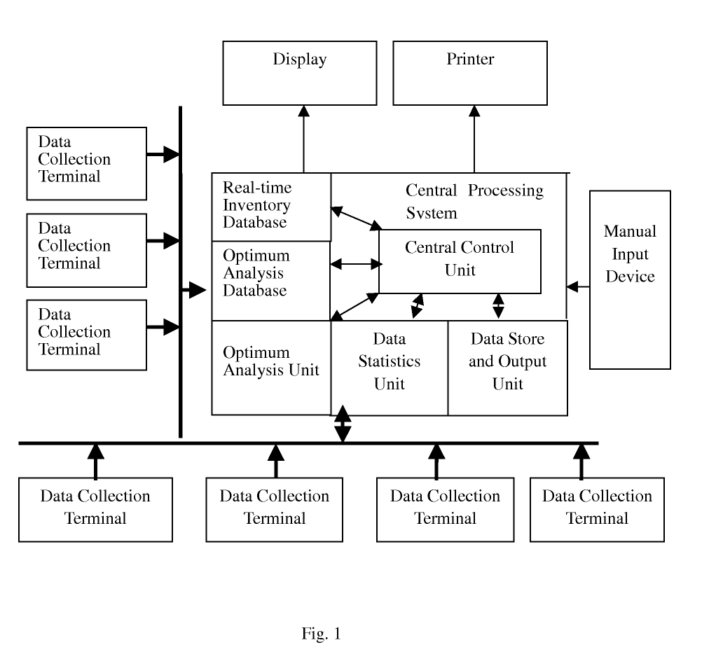

With reference to FIG. 1, a control system for enterprise production based on inventory data, comprising a central processing system and a or more data collection terminal which exchanges data with the central processing system, wherein said data collection terminal collects the incoming/discharging data of all goods and delivered the data to the said central processing system, which counts the said data to get statistics and store it; the said central processing system is set up with a real-time inventory database, a optimum analysis database, a data statistics unit, an optimum analysis unit, a data store and output unit, a manual input device and a central control unit; the said data statistics unit is applied to get the incoming/discharging data of all goods collected by data terminal, read and make statistical calculation of the corresponding data in real-time inventory database, acquire the storage data, incoming/discharging time data, and goods character data of all goods, and delivery these data to real-time inventory database to store through the said data store and output unit; the said optimum analysis unit reads the storage data, incoming/discharging time data and goods character data of all goods in real-time inventory database, reads optimum program and optimum parameter of optimum analysis database to make optimum calculation: when the relevant material on one production line is disproportionate, to generate proportional imbalance information of the production line, when the storage of one goods exceeds the upper limit of optimum storage, to generate overstocking signal of the goods, when the storage of one goods is less than the lower limit of optimum storage, to generate stock-out signal and when the inventory time of one goods is achieving the alarm time, to generate alarm signal of overtime inventory and save signals in optimum analysis database to stock and display alarm by data store and output unit; the said data store and output unit is used to receive data from data statistics unit, optimum analysis unit and manual input device, and delivery the data to the relevant database for stock, or to read data in a corresponding database according to an instruction from natural data statistics unit, optimum analysis unit and manual input device and display these data; the said central control unit is used to control the coordination among the said data statistics unit, optimum analysis unit, data store and output unit as well as manual input device.

This system takes the computer information processing as the major management tool, makes automatic management for various enterprises, especially the large industrial enterprise and commercial enterprise, in which the hardware of computer system comprises a certain number of incoming/discharging data collection terminals and central processing systems, and the location of warehouse is classified into a number of areas; the said incoming/discharging data collection terminal is used to collect the incoming/discharging information, and transfers the collected goods information to the said central processing system; when goods are stocked in the warehouse, the said central processing system, supported by the classification database and real-time inventory database, would determine the store area and location of incoming, send the goods store instruction to operator or automatic transfer device, and record the incoming data into the real-time inventory database; before goods are discharged from warehouse, input discharge instruction to the said central processing system manually or mechanically, then the said central processing system would read the data of real-time inventory database and send the goods extraction instruction to operator or automatic transfer device, according to the method of “first in, first out” to determine the location of discharged goods; when goods are really discharged from warehouse, record the discharging data from incoming/discharging data collection terminal into the real-time inventory database; the said incoming/discharging information is collected through mobile or fixed barcode recognizer and manual output according to the practical situation of all goods, and the said barcode recognizer is the mobile barcode recognizer, communicated with the said central processing system by wire or wireless method; the said mobile barcode recognizer is equipped with display to show the read barcode information and the inventory management information, and the manual input device to input information manually; the said central processing system comprises central processing system and network controller; the said network controller is communicated with central processing system and barcode recognizer respectively through wire or wireless method, transfers the information sent by central processing system to barcode recognizer, and transfers the information collected by code recognizer to central processing system; the said network controller is equipped with wire network connection port and links the said central processing system through the port and wire network, to converse and optimize the communication protocol of central processing system and mobile barcode recognizer; the said central processing system obtains the information from mobile barcode recognizer by network controller and sends the inventory management information to the mobile barcode recognizer; the said central processing system and network controller is adopted with TCP/IP Protocol to make communication; more the said network controllers could be set up according to the practical needs, and each network controller connects one or more central processing system; the said warehouse location is zoned based on the specific situation of enterprise, comprising through space, transfer space, and permanent-stocking space, in which the said through space is equipped with plane shelf, the said transfer space is equipped with stereo shelf, and the said permanent-stocking space is equipped with gravity shelf.

The optimization for inventory made by central processing system consists of the optimum control of storage and the optimum of inventory time of all goods. According to the specific situation of enterprise, the control upper limit and lower limit of proper storage and proper inventory time are set up for all goods, the warning would automatically display when it exceeds the control line, and it is more important that it enables to find the imbalance during production process and find the operation management problems according to consumption of various raw material on the same production chain and warehouse proportion, and remind manager to take care of the change of market and operation status, according to the warehouse situation of final products and the change of incoming/discharging time; the inventory control line is set up with the personal experience of customer and management data analysis, and customer is allowed to manually make terminable and permanent emendation according to practical demands; for industrial enterprise and other enterprises in need, this management system should obtain production or sales information through data exchange and manual input, to calculate and emend the control line based on the set method; through setting the data interface, it offers possibilities to the unified management system for production, supply and sell.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A control system for enterprise production based on inventory data, comprising
a central processing system; and
one or more data collection terminals which exchange data with the central processing system,
wherein said data collection terminal collects incoming/discharging data of all goods and delivers the data to the central processing system, which counts the data to obtain statistics and store it,
wherein the central processing system includes a real-time inventory database, a optimum analysis database, a data statistics unit, an optimum analysis unit, a data store and output unit, a manual input device and a central control unit,
wherein the data statistics unit is operable to obtain the incoming/discharging data of all goods collected by data terminal, read corresponding data in real-time inventory database to make statistical calculation, acquire storage data, incoming/discharging time data and goods character data of all goods, and deliver these data to the real-time inventory database and store them in the data store and output unit,
wherein the optimum analysis unit reads the storage data, incoming/discharging time data and goods character data of all goods in the real-time inventory database, reads optimum program and optimum parameter of optimum analysis database to make optimum calculation including: when the relevant material on one production line is disproportionate, to generate proportional imbalance information of the production line, when the storage of one goods exceeds the upper limit of optimum storage, generates a overstocking signal of the goods, when the storage of one goods is less than the lower limit of optimum storage, to generate stock-out signal and when the inventory time of one goods is achieving the alarm time, to generate an alarm signal of overtime inventory and save the signal in optimum analysis database to stock and display the alarm through the data store and output unit,
wherein the data store and output unit is operable to receive data from the data statistics unit, the optimum analysis unit and the manual input device, and deliver the data to the relevant database for stock, or to read data in a corresponding database and display the data according to an instruction from the natural data statistics unit, the optimum analysis unit and the manual input device, and
wherein the central control unit controls coordination among the data statistics unit, the optimum analysis unit, the data store and output unit and the manual input device.

2. The system of claim 1, wherein the central control system includes a classification database and a location distribution unit for inventory zoning management, wherein the classification database is used to store the goods zoning warehouse capacity and goods location occupation data of a controlled warehouse, wherein the said location distribution unit reads the relevant goods zoning warehouse capacity data and goods location occupation data to distribute location of the relevant zone for stock based on the incoming/discharging goods character data.

3. The system of claim 2, wherein the incoming/discharging data collection terminal is used to collect incoming/discharging information and transfer the information to the central processing system; supported by the classification database and real-time inventory database, the central processing system determines the store area and location of incoming, sends a goods store instruction to operators or an automatic transfer device and records the incoming goods data into the real-time inventory database when goods are stocked in the warehouse; when goods are discharged from warehouse, a discharge instruction is input to the central processing system manually or mechanically, then, the central processing system reads the data of real-time inventory database, determines the location of discharged goods based on the standard of “first in, first out” and send the goods extraction instruction to operators or an automatic transfer device; when goods are really discharged from warehouse, the central processing system records the discharging data from the incoming/discharging data collection terminal into the real-time inventory database.

4. The system of claim 1, wherein the incoming/discharging information is collected through a mobile or fixed barcode recognizer and manually outputted according to practical situation of all goods.

5. The system of claim 4, wherein the data collection terminal communicates with the central processing system by a wired or wireless method.

6. The system of claim 5, wherein the data collection terminal is a mobile barcode recognizer equipped with a displayer to show the barcode information and the inventory management information.

7. The system of claim 6, further comprising a manual input device to input information manually.

8. The system of claim 7, further comprising a network controller, wherein the network controller communicates with the central processing system and the barcode recognizer respectively by a wire or wireless method, transfers the information from the central processing system to the barcode recognizer and transfers the information collected by the code recognizer to the central processing system.

9. The system of claim 8, wherein the network controller includes a wire network communication port and links the central processing system through the communication port and wire networks to converse and optimize the communication protocol between the central processing system and the mobile barcode recognizer.

10. The system of claim 9, wherein the central processing system obtains the information from the mobile barcode recognizer by the network controller and sends the inventory management information to the mobile barcode recognizer.

11. The system of claim 10, wherein the said central processing system and the network controller communicate with each other using a TCP/IP Protocol.

12. The system of claim 3, wherein the incoming/discharging information is collected through a mobile or fixed barcode recognizer and manually outputted according to practical situation of all goods.

13. The system of claim 12, wherein the data collection terminal communicates with the central processing system by a wired or wireless method.

14. The system of claim 13, wherein the said data collection terminal is a mobile barcode recognizer equipped with a displayer to show the barcode information and the inventory management information.

15. The system of claim 14, further comprising a manual input device to input information manually.

16. The system of claim 15, further comprising a network controller, wherein the network controller communicates with the central processing system and the barcode recognizer respectively by a wire or wireless method, transfers the information from the central processing system to the barcode recognizer and transfers the information collected by the code recognizer to the central processing system.

17. The system of claim 16, wherein the network controller includes a wire network communication port and links the central processing system through the communication port and wire networks to converse and optimize the communication protocol between the central processing system and the mobile barcode recognizer.

18. The system of claim 17, wherein the central processing system obtains the information from the mobile barcode recognizer by the network controller and sends the inventory management information to the mobile barcode recognizer.

19. The system of claim 18, wherein the said central processing system and the network controller communicate with each other using a TCP/IP Protocol.
